(19) United States
(12) Patent Application Publication
(10) Pub. No.: US 2023/0092475 A1
(43) Pub. Date: Mar. 23, 2023

(54) INFORMATION PROCESSING METHOD, APPARATUS AND DEVICE, AND STORAGE MEDIUM

(71) Applicant: TENCENT TECHNOLOGY (SHENZHEN) COMPANY LIMITED, Shenzhen (CN)

(72) Inventor: Jiawei BU, Shenzhen (CN)

(21) Appl. No.: 18/072,938

(22) Filed: Dec. 1, 2022

Related U.S. Application Data
(63) Continuation of application No. PCT/CN2022/088942, filed on Apr. 25, 2022.

(30) Foreign Application Priority Data
May 21, 2021 (CN) 202110556210.9

(51) Int. Cl. H04L 67/55; H04L 9/40

(52) U.S. Cl. CPC H04L 67/55; H04L 63/10

(57) ABSTRACT

An information processing method includes: receiving a sharing operation for information in an information page, the information comprises an object to be pushed; in response to the sharing operation, presenting push information associated with the object; and sharing the information in response to a determination instruction for the push information, and presenting the information and a push portal corresponding to the push information in a corresponding sharing page.

### CROSS-REFERENCES TO RELATED APPLICATIONS

This application is a continuation application of PCT Patent Application No. PCT/CN2022/088942, filed on Apr. 25, 2022, which claims priority to Chinese Patent Application No. 202110556210.9 filed on May 21, 2021, the entire contents of both of which are incorporated herein by reference.

### FIELD OF THE TECHNOLOGY

The present disclosure relates to multimedia technologies, and in particular, to an information processing method and apparatus, a device, a computer-readable storage medium and a computer program product.

### BACKGROUND OF THE DISCLOSURE

In related art, when a social network user create a post, they may need to manually label an object shown in the post before sharing it on a social media, which is inconvenient for the user to share interesting places or items with their friends or followers. In addition, a social network user that browses a post may also want to learn detailed information of places or items shown in the post, such as names and access information of the places or items.

### SUMMARY

An embodiment of the present disclosure provides an information processing method, including: receiving a sharing operation for information in an information page, the information comprises an object to be pushed; in response to the sharing operation, presenting push information associated with the object; and sharing the information in response to a determination instruction for the push information, and presenting the information and a push portal corresponding to the push information in a corresponding sharing page.

An embodiment of the present disclosure provides an information processing apparatus, including: a receiving module configured to receive a sharing operation for information in an information page, the information comprises an object to be pushed; a presenting module configured to in response to the sharing operation, present push information associated with the object; and a processing module configured to share the information in response to a determination instruction for the push information, and present the information and a push portal corresponding to the push information in a corresponding sharing page.

An embodiment of the present disclosure provides an electronic device, including: a memory, configured to store executable instructions; and a processor, configured to implement the information processing method provided in the embodiments of the present disclosure when executing the executable instructions stored in the memory.

An embodiment of the present disclosure provides a non-transitory computer-readable storage medium storing executable instructions, the executable instructions, when executed by a processor, causing a processor to perform the information processing method provided in this embodiment of the present disclosure.

By applying the embodiments of the present disclosure, when a user shares information, in response to a sharing operation for the information, when the information includes an object to be pushed, push information associated with the object to be pushed is presented; and in response to a determination instruction for the push information, the information is shared, and the shared information and a push portal corresponding to the push information are presented in a corresponding sharing page. In this way, the shared information is displayed, and the push portal of the push information associated with the object to be pushed in the information is displayed at the same time, thereby meeting increasingly diversified display demands for user information sharing. Moreover, the user may implement the push of the push information by means of sharing information to form a decentralized push ecosystem, thereby improving the push universality of the push information, and saving the push cost. Furthermore, since the relationship chain of users is based on real life, when these users share related push information by means of sharing information, it is not easy for the related users who read the information to resist, thereby improving the push accuracy of the push information and being favorable for improving the conversion rate.

### BRIEF DESCRIPTION OF THE DRAWINGS

FIG. 1 is a schematic architectural diagram of an information processing system 100 provided by an embodiment of the present disclosure.

FIG. 2 is a schematic structural diagram of an electronic device 500 provided by an embodiment of the present disclosure.

FIG. 3 is a schematic flowchart of an information processing method provided by an embodiment of the present disclosure.

FIG. 4 is a schematic diagram of a sharing interface of information provided by an embodiment of the present disclosure.

FIG. 5 is a schematic diagram of a prompt interface of push authorization provided by an embodiment of the present disclosure.

FIG. 6 is a schematic diagram of sharing mode setting provided by an embodiment of the present disclosure.

FIG. 7 is a schematic diagram of a display interface of push information provided by an embodiment of the present disclosure.

FIG. 8 is a schematic diagram of a display interface of push information provided by an embodiment of the present disclosure.

FIG. 9 is a schematic diagram of a display interface of push information provided by an embodiment of the present disclosure.

FIG. 10 is a schematic diagram of an authorization interface of reward information provided by an embodiment of the present disclosure.

FIG. 11 is a schematic diagram of an authorization interface of reward information provided by an embodiment of the present disclosure.

FIG. 12 is a schematic diagram of an authorization interface of reward information provided by an embodiment of the present disclosure.

FIG. 13 is a schematic architectural diagram of an information processing system provided by an embodiment of the present disclosure.

FIG. 14 is a schematic diagram of a product interface for information processing provided by an embodiment of the present disclosure.

FIG. 15 is a schematic flowchart of an information processing method provided by an embodiment of the present disclosure.

FIG. 16 is a schematic structural diagram of an information processing apparatus provided by an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

In the following descriptions, the comprised term “first/second” is merely intended to distinguish similar objects but does not necessarily indicate a specific order of an object. It may be understood that “first/second” is interchangeable in terms of a specific order or sequence if permitted, so that the embodiments of the present disclosure described herein can be implemented in a sequence in addition to the sequence shown or described herein.

Unless otherwise defined, meanings of all technical and scientific terms used in this specification are the same as those usually understood by a person skilled in the art to which the present disclosure belongs. Terms used in this specification are merely intended to describe objectives of the embodiments of the present disclosure, but are not intended to limit the present disclosure.

Before the embodiments of the present disclosure are further described in detail, nouns and terms involved in the embodiments of the present disclosure are described. The nouns and terms provided in the embodiments of the present disclosure are applicable to the following explanations.

1) Clients: Applications running in terminals to provide various services, such as an instant messaging client, a short video client, a video playing client, and a learning client.

2) In response to: It is used for representing a condition or status on which one or more operations to be performed depend. When the condition or status is satisfied, the one or more operations may be performed immediately or after a set delay.

3) Location based services (LBS): Use various types of location technologies to obtain the current location of a terminal, and provide information resources and basic services to the terminal through the mobile Internet. Users may determine their own spatial locations based on the location technologies in the LBS, and then obtain location-related resources and information through the mobile Internet. Multiple information technologies, such as mobile communication, Internet, spatial orientation, location information and big data, are fused in the LBS, and mobile Internet service platforms are used for data updating and interaction, so that users may obtain corresponding services through spatial orientation.

4) Social advertising push: By means of a large number of label categories generated by deep analysis of user data as well as continuously improved technologies such as cross-screen orientation, crowd expansion and intelligent bidding, help advertisers (such as merchants) to realize user connection dialog to ultimately achieve marketing objectives; and furthermore, by means of the development of data and capabilities, cooperate with traffic owners and advertising technology partners to build an open and win-win marketing ecosystem and jointly promote the development of the digital marketing industry.

5) Point of interest (POI): In a geographic information system, a POI may be a house, a shop, a mailbox, a bus station, etc.

In related art, the form of social advertising mainly relies on the centralized traffic allocation of a traffic platform and relies on advertising targeting conditions to select targeted groups that may achieve commercial target conditions, so as to select advertising targeting conditions consistent with the brand positioning of merchants, target groups, etc., and find groups in demand, thereby implementing targeted advertising. However, this advertising form often makes users feel resistant, resulting in lower accuracy and lower conversion efficiency of advertising.

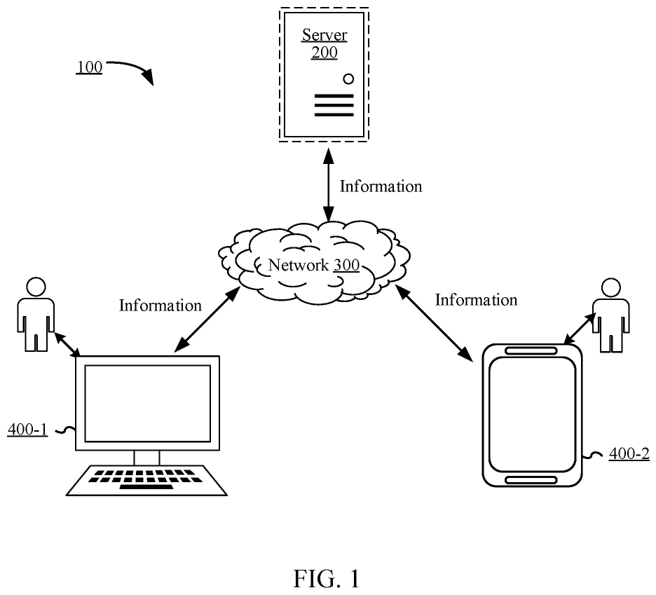

Based on the above explanation of the expressions and terms involved in the embodiments of the present disclosure, an information processing system provided by an embodiment of the present disclosure is described below. Referring to FIG. 1, FIG. 1 is a schematic architectural diagram of an information processing system 100 provided by an embodiment of the present disclosure. In order to support an exemplary application, terminals (terminals 400-1 and 400-2 are shown exemplarily) are connected to a server 200 through a network 300, the network 300 may be a wide area network, a local area network, or a combination of the wide area network and the local area network, and data transmission is achieved by a wireless link.

In practical applications, the terminal may be various types of user terminals, such as a smartphone, a tablet computer and a notebook computer, or may be a desktop computer, a television or a combination of any two or more of these data processing devices. The terminal is provided with a client, such as an instant messaging client, a short video client, a video playing client, and a learning client. The server 200 is a back-end server corresponding to the client, which may be a separately configured server supporting various services, a server cluster, or a cloud server.

When a user opens the client on the terminal to share information, the terminal receives a sharing operation for information in an information page, and transmits a recognition request for the information to the server 200 in response to the sharing operation; the server 200 performs object recognition on the information based on the recognition request, obtains push information associated with the object to be pushed when the recognition result indicates that the information includes an object to be pushed, and returns the push information to the terminal; and the terminal presents the push information associated with the object to be pushed, shares the information in response to a determination instruction for the push information, and presents the information and the push portal corresponding to the push information in a corresponding sharing page.

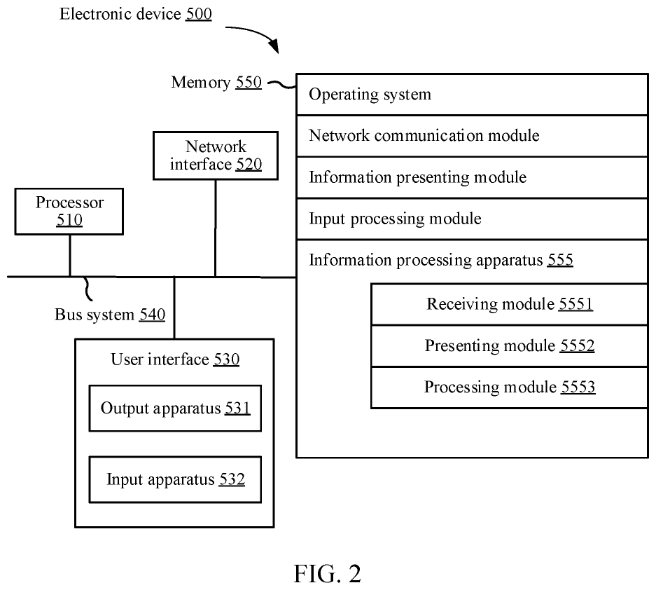

Referring to FIG. 2, FIG. 2 is a schematic structural diagram of an electronic device 500 provided by an embodiment of the present disclosure. In practical applications, the electronic device 500 may be the terminal or the server 200 shown in FIG. 1. Taking the terminal shown in FIG. 1 as the electronic device as an example, the electronic device for implementing the information processing method provided by this embodiment of the present disclosure is described. The electronic device 500 shown in FIG. 2 includes: at least one processor 510, a memory 550, at least one network interface 520, and a user interface 530. All the components in the electronic device 500 are coupled together by using a bus system 540. It may be understood that the bus system 540 is configured to implement connection and communication between the components. In addition to a data bus, the bus system 540 further includes a power bus, a control bus, and a state signal bus. However, for ease of clear description, all types of buses are marked as the bus system 540 in FIG. 2.

The processor 510 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, or the like.

The user interface 530 comprises one or more output apparatuses 531 that can display media content, comprising one or more speakers and/or one or more visual display screens. The user interface 530 further comprises one or more input apparatuses 532, comprising user interface components that facilitate inputting of a user, such as a keyboard, a mouse, a microphone, a touch display screen, a camera, and other input button and control.

The memory 550 may be a removable memory, a non-removable memory, or a combination thereof. Exemplary hardware devices comprise a solid-state memory, a hard disk drive, an optical disc driver, or the like. The memory 550 may include one or more storage devices away from the processor 510 in a physical position.

The memory 550 comprises a volatile memory or a non-volatile memory, or may comprise both a volatile memory and a non-volatile memory. The non-volatile memory may be a read-only memory (ROM). The volatile memory may be a random access memory (RAM). The memory 550 described in this embodiment of the present disclosure is to include any other suitable type of memories.

In some embodiments, the information processing apparatus provided in the embodiments of the present disclosure may be implemented in the form of software. FIG. 2 shows an information processing apparatus 555 stored in the memory 550, which may be software in the form of a program and a plug-in, including the following software modules: a receiving module 5551, a presenting module 5552 and a processing module 5553. These modules are logical modules, and may be randomly combined or further divided based on a function to be performed. The following describes a function of each module.

In some other embodiments, the information processing apparatus provided in this embodiment of the application may be implemented by using hardware. For example, the information processing apparatus provided in this embodiment of the application may be a processor in a form of a hardware decoding processor, programmed to perform the information processing method provided in the embodiments of the application. For example, the processor in the form of a hardware decoding processor may use one or more application-specific integrated circuits (ASIC), a DSP, a programmable logic device (PLD), a complex programmable logic device (CPLD), a field-programmable gate array (FPGA), or other electronic components.

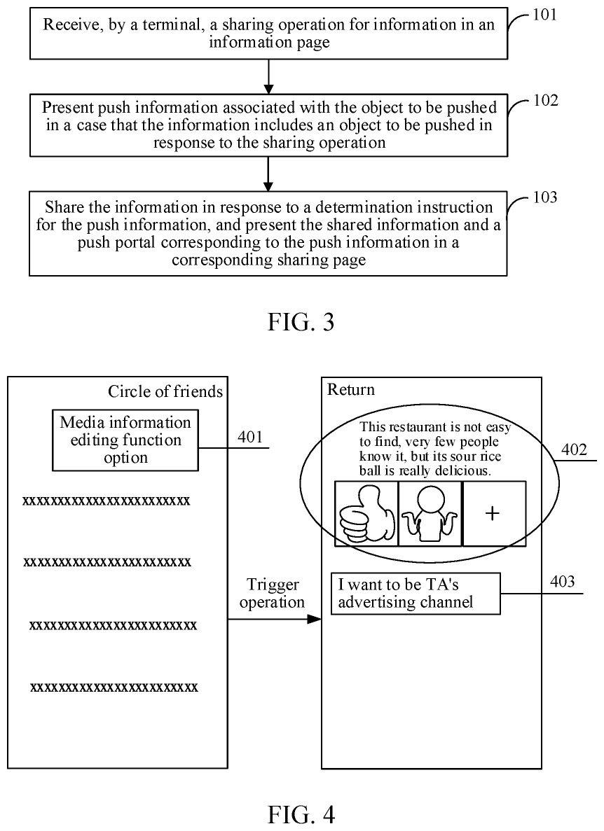

Based on the above descriptions for the information processing system and the electronic device provided by the embodiments of the present disclosure, an information processing method provided by an embodiment of the present disclosure is described below. In practical implementations, an information processing method provided by an embodiment of the present disclosure may be implemented separately by the server 200 or the terminal shown in FIG. 1, or may be implemented cooperatively by the server 200 and the terminal shown in FIG. 1. With reference to FIG. 1 and FIG. 3, FIG. 3 is a schematic flowchart of an information processing method provided by an embodiment of the present disclosure, and a terminal shown in FIG. 1 is taken to implement the information processing method provided by this embodiment of the present disclosure as an example for description.

Step 101: Receive, by the terminal, a sharing operation for information in an information page.

In practical applications, the terminal is provided with a client, such as an instant messaging client, a social client, a learning client or a game client, and a user may communicate with other users through an information page presented on the client (such as circle of friends, talk, forum or microblog), such as sharing information through an information page for other users to browse and view, or browsing and viewing information shared by other users through an information page, or collecting information through an information page for saving and viewing.

In some embodiments, the terminal may receive a sharing operation for information in an information page by the following method: present an information editing function option in an information page; present the edited information and a sharing function option corresponding to the information in the information page in response to an information editing operation triggered based on the information editing function option; and receive a sharing operation for the information triggered based on the sharing function option.

In practical applications, when a user wants to share (or publish) information in an information page such as circle of friends, talk or forum, the user may obtain the information to be shared by triggering the information editing function option in the information page for editing, and share the information obtained by editing, where the information obtained by editing may be expressed in at least one of the following forms: texts, images, videos or voices. The texts, images, videos or voices here may be collectively referred to as media information. In this expression form, the information in the embodiments of the present disclosure may also be referred to as media information, and correspondingly, the information page for a sharing operation of information may also be referred to as a media information page.

Referring to FIG. 4, FIG. 4 is a schematic diagram of a sharing interface of information provided by an embodiment of the present disclosure. The terminal presents an information editing interface in response to a trigger operation for an information editing function option 401, and presents the edited information 402 in response to an information editing operation triggered based on the information editing interface, where the information includes text contents, additional images and a sharing function option 403 corresponding to the information 402. When a user triggers the sharing function option 403, the terminal receives a sharing operation for information triggered based on the sharing function option 403, and shares the edited information 402 in response to the sharing operation.

In some embodiments, the terminal may receive a sharing operation for information in an information page by the following method: present a sharing function option for the information in the detail page when the information page is a detail page of information; present an object option including at least one sharing object in response to a trigger operation for the sharing function option; and receive a selection operation for a target object in the at least one sharing object triggered based on the object option, and use the selection operation as a sharing operation for the information. Correspondingly, the terminal may present the information and the push portal corresponding to the push information in a corresponding sharing page by the following method: present a chat page between a current user and the target object, and present the information and the push portal corresponding to the push information in the chat page.

In practical applications, a user may share the information with a session friend when browsing information in a detail page of the information. When sharing information, the user may share the information directly or indirectly. For example, the user may directly share the information to be shared in the detail page to a chat page between a current user and a target object (sharing object) by means of forwarding; or the user may also take a screenshot of the detail page first to obtain a screenshot image including the information to be shared, and then share the screenshot image to the chat page between the current user and the target object (sharing object), so as to present the shared information in a session interface; and when the information includes an object to be pushed, a push portal of push information associated with the object to be pushed is further presented in the session interface.

In practical implementations, information and a sharing function option for the information are presented in a detail page of the information, an object selection page is presented in response to a trigger operation for the sharing function option, and an object option including at least one sharing object is presented in the object selection page; and when a user selects an object option of a target object, the selection operation is a sharing operation for the information.

In some embodiments, the terminal may receive a sharing operation for information in an information page by the following method: presenting an information option in the chat page when the information page is a chat page between a current user and a target sharing user; and receiving an information addition operation for the information based on the information option, and using the information addition operation as a sharing operation for the information. Correspondingly, the terminal may present the information and the push portal corresponding to the push information in a corresponding sharing page by the following method: present the information and the push portal corresponding to the push information in the chat page.

In practical applications, during the session, a user may edit and share a session message based on the chat page, the chat page is the information page (or media information page), the edited session message is the information (or media information) to be shared, and the form of the information includes at least one of the following: texts, pictures, videos, and voices. For example, session text information may be obtained by editing with a text edit box, and information such as images and videos may be added from local or direct shooting through the information option. Correspondingly, after the information is shared, a sharing page for sharing the information is the chat page, that is, the shared information and a push portal of push information associated with the object to be pushed are presented in the chat page.

Step 102: Present push information associated with the object to be pushed when the information includes an object to be pushed in response to a sharing operation.

In practical applications, an object to be pushed may be an article to be pushed or a POI to be pushed to a user, where the POI may be referred to as an entity to be pushed. For example, if the information is a video to be shared and the video to be shared includes a target person wearing a dress, the object to be pushed may be the dress worn by the target person. In another example, if the information is an image to be shared and the image to be shared includes POIs, such as restaurants and museums, the object to be pushed may be entities to be pushed, such as restaurants and museums.

The push information is text information or description information pushed for the object to be pushed. For example, if the object to be pushed is an article to be pushed, the associated push information may be the name, brand, price, xx style and other introduction information of the article to be pushed; and when the object to be pushed is a POI, the associated push information may be the name, location and other introduction information of the POI, such as the name, address, comment exposure price and other information of a merchant. When push information is presented, the push information may be presented in an area associated with the object to be pushed (such as above or below the object to be pushed) in the information.

In some embodiments, before presenting push information associated with an object to be pushed, the terminal may determine that the information includes the object to be pushed by the following method: perform object recognition on the information to obtain at least one object included in the information; and respectively match each object with the pre-stored object to be pushed, and determine that the information includes the object to be pushed when there is an object matched with the pre-stored object to be pushed.

In practical implementations, when the terminal performs object recognition on the information to be shared, the information may be inputted into a pre-trained object recognition model to obtain at least one object included in the information, such as clothes, jewelry, glasses and watches, and each object obtained by recognition is matched with the pre-stored object to be pushed to obtain a matching result; if the matching result indicates that there is an object matched with the pre-stored object to be pushed in the at least one object obtained by recognition, it is determined that the information includes the object to be pushed; and the object matched with the pre-stored object to be pushed in the at least one object obtained by recognition from the information is determined as the object to be pushed. During matching, when a matching degree (such as similarity value) between the object obtained by recognition and the pre-stored object to be pushed exceeds a matching degree threshold (for example, may be set as 80%), it may be determined that the object obtained by recognition is matched with the pre-stored object to be pushed.

For example, after object recognition is performed on information, objects included in the information are respectively obtained: a dress, a watch and a hat. The dress, the watch and the hat are respectively matched with each of the pre-stored objects to be pushed, and obtained matching degrees are sequentially: 85%, 30% and 60%. Assuming that the matching is successful when the matching degree exceeds 80%, it may be seen that the “dress” obtained by recognition from the information is matched with the pre-stored object to be pushed successfully, so it is determined that the information includes an object to be pushed, that is, the dress.

In some embodiments, when an object to be pushed is a POI, before presenting push information associated with the object to be pushed, the terminal may determine that the information includes the object to be pushed by the following method: perform POI recognition on the information to obtain a POI corresponding to the information, and perform location recognition on the information to obtain a geographical location associated with the information; obtain a pre-stored reference POI in a location area where the geographical location is located; and match the POI with the reference POI, and determine that the information includes the reference POI when the POI is matched with the reference POI, so as to use the reference POI as the object to be pushed.

In practical implementations, the terminal may further transmit a recognition request for information to a server, the server obtains the information requested for recognition by the recognition request in response to the recognition request, and the information is inputted into a trained recognition model based on a neural network to obtain a POI corresponding to the information. For example, if the information includes images or videos, POI recognition is performed on the images or videos to obtain information, such as billboards, signboards or store scenes, included in the information. During location recognition, location recognition may be performed on the information based on an LBS technology to obtain a geographical location associated with the information. In practical applications, a merchant uploads recognition images including merchant information, such as billboards, signboards or store scenes, to a server. In order to improve the robustness of subsequent matching, a user may upload recognition images under different lighting conditions, different weather conditions and different angles. The server performs POI recognition on the recognition image uploaded by the merchant. For example, the recognition image is inputted into the trained recognition model based on the neural network to obtain a reference POI corresponding to the merchant information, and the reference POI corresponding to each merchant is stored in the server.

The server matches the recognized POI with the reference POI pre-stored by the merchant. When the matching degree between the recognized POI and the reference POI exceeds a matching degree threshold, it is determined that the POI is matched with the reference POI, at this time, it is determined that the information includes the reference POI pre-stored by the merchant, and the reference POI is used as the object to be pushed. When the matching degree between the recognized POI and the reference POI is lower than a matching degree threshold, it is determined that the matching between the POI and the reference POI fails, and at this time, it is determined that the information does not include the reference POI pre-stored by the merchant.

In some embodiments, after receiving a sharing operation for information in an information page, the terminal may further present push authorization information corresponding to the information, where the push authorization information is used for obtaining the push authorization for the object to be pushed in the information. Correspondingly, the terminal may present push information associated with the object to be pushed when the information includes an object to be pushed by the following method: present push information associated with the object to be pushed when the information includes an object to be pushed in response to an authorization instruction triggered for the push authorization information.

In practical applications, in order to protect the privacy of the user, when the user shares the information, the push authorization information may be presented by a pop-up window, so as to remind the user whether to perform authorization to push the object to be pushed in the information. When the information includes the object to be pushed and is authorized by the user, the push information associated with the object to be pushed is presented. When the information includes the object to be pushed but is not authorized by the user, the push information associated with the object to be pushed is not presented.

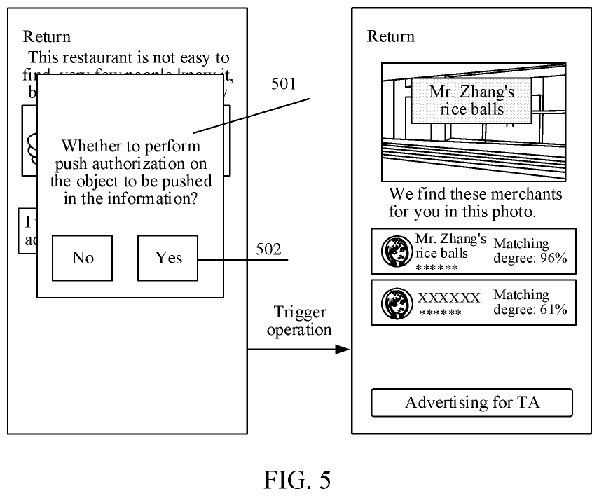

Referring to FIG. 5, FIG. 5 is a schematic diagram of a prompt interface of push authorization provided by an embodiment of the present disclosure. After receiving a sharing operation for information, the terminal presents push authorization information 501, such as “whether to perform push authorization on the object to be pushed in the information”, in a pop-up window. When a user triggers a determination key 502 based on the push authorization information 501, the terminal presents push information associated with the object to be pushed when the information includes an object to be pushed in response to an authorization instruction triggered for a trigger operation on the determination key 502.

In some embodiments, before presenting push information associated with the object to be pushed, the terminal may further present a sharing setting interface of information, and present a sharing push function option in the sharing setting interface; and set a sharing mode of information to a sharing push mode in response to a trigger operation for the sharing push function option. Correspondingly, the terminal may present push information associated with the object to be pushed when the information includes an object to be pushed by the following method: present push information associated with the object to be pushed when a sharing mode of information is a sharing push mode and the information includes an object to be pushed.

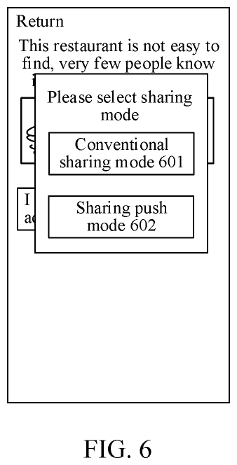

Referring to FIG. 6, FIG. 6 is a schematic diagram of sharing mode setting provided by an embodiment of the present disclosure. The terminal presents a sharing setting interface in response to a sharing operation, and presents selectable sharing modes, such as a sharing mode 601 and a sharing push mode 602, in the sharing setting interface, where the sharing mode 601 is used for indicating that only the information is shared, but the object to be pushed is not shared even if the information includes an object to be pushed; and the sharing push mode 602 is used for indicating that when the information is shared, if the information includes an object to be pushed, the push information associated with the object to be pushed is shared. That is, after a user sets a sharing mode of information to the sharing mode, in a process of sharing the information, even if the information includes an object to be pushed, only the information is presented, but the push information associated with the object to be pushed is not presented; and after the user sets a sharing mode of information to the sharing push mode, when the information includes an object to be pushed, the shared information is presented, and the push information associated with the object to be pushed, included in the information, is also presented.

By means of the above method, when the terminal receives a sharing operation for information, the user may set and select a sharing mode of information based on the sharing setting interface according to own wishes, thereby meeting the diversified needs of users to share information.

In some embodiments, the terminal may present push information associated with the object to be pushed by the following method: presenting an object selection page corresponding to the at least two objects to be pushed when there are at least two objects to be pushed; and presenting push information associated with the target push object in response to a selection operation for a target push object in the object selection page.

When there are multiple (two or more) objects to be pushed in the information, the user may select a target push object from the objects to be pushed, so as to present push information associated with the selected target push object.

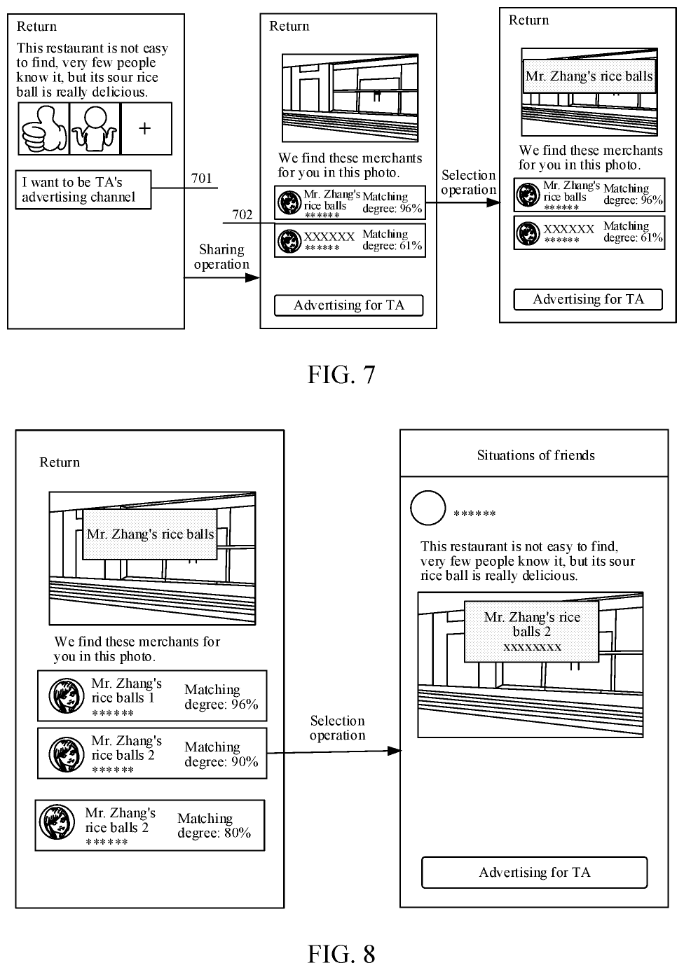

Referring to FIG. 7, FIG. 7 is a schematic diagram of a display interface of push information provided by an embodiment of the present disclosure. When a user clicks a push function option 701, such as “I want to be TA's advertising channel”, the terminal receives a sharing operation triggered based on a click operation for the push function option. In response to the sharing operation, when there are multiple objects to be pushed in the information, an object selection page 702 is presented, and multiple selectable push object options are presented in the object selection page 702. When the user selects a push object option corresponding to a target push object, push information associated with the target push object is presented.

In some embodiments, when the information includes at least two objects to be pushed, the terminal may further predict a target push object to be shared by the following method: obtain a sharing reference feature of the information, where the sharing reference feature includes at least one of the following: a conversion rate (such as click rate or purchase rate) corresponding to each push object, a social relationship between a current user (sharer of information) and a target sharing user (receiver of information), and user features (such as hobbies and historical click features) of a target sharing user (receiver of information); and invoking a machine learning model for prediction processing based on the sharing reference feature to obtain a target push object, and presenting push information associated with the target push object. After the information is shared, the shared information is presented in a sharing page, and the push information associated with the target push object and a corresponding push portal are presented at the same time. The machine learning model is obtained by training based on sharing reference features of information samples and marked push objects. In practical applications, the above machine learning model may be a neural network model (such as a convolutional neural network, a deep convolutional neural network, or a fully connected neural network), a decision tree model, a gradient-boosted tree, a multilayer perceptron, a support vector machine, etc. The specific type of the machine learning model is not limited in the embodiments of the present disclosure.

It may be understood that by means of the above method, when the current user shares the same piece of information including multiple objects to be pushed to different target objects, the target push objects predicted based on the above method may be different. That is, when terminals on different target object sides present the same piece of information shared by the current user, the presented push information and corresponding push portals may be different. For example, information A includes two different objects to be pushed, namely: an object 1 to be pushed, and an object 2 to be pushed. If the current user shares the information A in the form of a circle of friends, the information displayed on some friend-side terminals may be associated with the object 1 to be pushed, and the information displayed on some friend-side terminals may be associated with the object 2 to be pushed. If the current user shares the information A to different target objects by means of session, the information displayed in session interfaces between the current user and different target objects may be different. If the information A is shared to a target object 1, the terminal presents push information associated with the object 1 to be pushed, included in the information A, in response to a sharing operation for the information A, the information A is shared to the terminal of the target object 1 in response to a determination operation for the push information associated with the object 1 to be pushed, and the push information associated with the object 1 to be pushed and a corresponding push portal are presented in a session interface between the current user and the target object 1. If the information A is shared to a target object 2, the terminal presents push information associated with the object 2 to be pushed, included in the information A, in response to a sharing operation for the information A, the information A is shared to the terminal of the target object 2 in response to a determination operation for the push information associated with the object 2 to be pushed, and the push information associated with the object 2 to be pushed and a corresponding push portal are presented in a session interface between the current user and the target object 2.

By means of the above method, the object to be pushed most in the information is predicted by means of invoking the machine learning model, which improves the prediction accuracy so as to achieve more accurate advertising effect, thereby being favorable for improving the conversion rate. Furthermore, when the same user shares the same information (including multiple objects to be pushed) to different users, the purpose of obtaining push information associated with different objects to be pushed by different users may be achieved, thereby meeting the diversified needs of information sharing.

Step 103: Share the information in response to a determination instruction for the push information, and present the shared information and a push portal corresponding to the push information in a corresponding sharing page.

The push portal may be an interactive portal of an object to be pushed, such as a detail portal, a purchase link, a promotion link, a group entry link, or an applet corresponding to the push information.

In some embodiments, before presenting push information associated with the object to be pushed, the terminal may further receive a selection instruction for target push information in the at least two pieces of push information when there are at least two pieces of push information; and use the target push information as push information to be shared in response to the selection instruction. Correspondingly, the terminal may share the information in response to a determination instruction for the push information, and present the information and the push portal corresponding to the push information in a corresponding sharing page by the following method: share the information in response to a determination instruction for the target push information, and present the information and the push portal corresponding to the target push information in a corresponding sharing page.

Referring to FIG. 8, FIG. 8 is a schematic diagram of a display interface of push information provided by an embodiment of the present disclosure. When there are multiple (two or more) pieces of push information associated with an object to be pushed, an information selection interface 801 is presented, and multiple selectable push information options are presented in the information selection interface 801. When a user selects target push information from multiple pieces of push information, the selected target push information may be presented as push information to be shared. In this way, the information is shared, and at the same time, a push portal corresponding to the selected target push information is presented in a corresponding sharing page.

In some embodiments, before presenting push information associated with the object to be pushed, the terminal may further predict the target push information to be shared when there are at least two pieces of push information associated with the object to be pushed by the following method: obtain multi-dimensional features, such as the conversion rate of each piece of push information for the object to be pushed, and the preference of the target sharing user of the information for each piece of push information; invoke a machine learning model for prediction processing based on the multi-dimensional features to predict the target push information; and use the target push information as the push information to be shared so as to present the target push information associated with the object to be pushed. In this way, the target push information (most suitable for being pushed) associated with the object to be pushed is predicted by means of invoking the machine learning model, which improves the prediction accuracy so as to achieve more accurate advertising effects, thereby being favorable for improving the conversion rate.

In some embodiments, the terminal may present push information associated with the object to be pushed when the information includes an object to be pushed by the following method: obtaining an object level of a current user and a push level corresponding to the push object when the information includes an object to be pushed; and presenting push information associated with the object to be pushed when the object level is not lower than the push level.

In practical applications, when the information includes an object to be pushed, the terminal may further transmit a push request for the object to be pushed to a server, where the push request carries a user identifier of the current user and an object identifier of the object to be pushed. After the server receives the push request, the object level of the current user is determined based on the user identifier in the push request, and at the same time, the push level of the object to be pushed is determined based on the object identifier in the push request. The object level is compared with the push level, and when the object level is not lower than the push level, the push information associated with the object to be pushed is presented.

The object level corresponds to the push level one by one. The object level may be determined based on the basic information of the current user, the number of fans, and the activity for the information (such as interactions of sharing, liking, commenting and forwarding). The push level is an object level which is set in advance by the merchant of the object to be pushed and has a push authority for the object to be pushed. If the object level of the current user is not lower than the push level of the object to be pushed, it indicates that the current user has a push authority for the object to be pushed, and at this time, the push information associated with the object to be pushed is presented.

In some embodiments, the terminal may present push information associated with the object to be pushed when the information includes an object to be pushed by the following method: turn the page to a push information page when the object to be pushed is a POI, present merchant information of a merchant associated with the POI in the push information page, and use the merchant information as the push information. Correspondingly, the terminal may share the information in response to a determination instruction for the push information, and present the information and the push portal corresponding to the push information in a corresponding sharing page by the following method: share the information in response to a determination instruction for the merchant information, and present the information and the push portal corresponding to the merchant information in a corresponding sharing page.

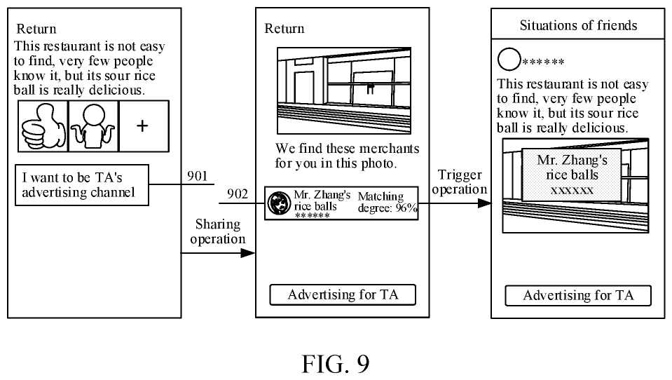

Referring to FIG. 9, FIG. 9 is a schematic diagram of a display interface of push information provided by an embodiment of the present disclosure. When a user triggers a push function option 901, such as “I want to be TA's advertising channel”, in an information page, the terminal receives a sharing operation triggered based on the trigger operation. In response to the sharing operation, when the information includes an object to be pushed and the object to be pushed is a POI “restaurant”, the page is turned to a push information page, and merchant information 902 of a merchant “Mr. Zhang's rice balls” associated with the POI “restaurant” is presented in the push information page. The information is shared in response to a determination instruction triggered based on the merchant information 902, and the information and the push portal corresponding to the merchant information of “Mr. Zhang's rice balls” are presented in a corresponding sharing page.

In some embodiments, after presenting the merchant information of the merchant associated with the POI in the push information page, the terminal may further present a confirmation function option corresponding to the merchant information by the following method: transmitting object information of a current user to a terminal corresponding to the merchant in response to a trigger operation for the confirmation function option; and triggering a determination instruction for the merchant information when an authorization sharing instruction triggered by the merchant based on the object information is received.

The object information may be the basic information of the current user (such as user data), the information of the number of fans, and the information of the activity for the information (such as interactive information of sharing, liking, commenting and forwarding). The merchant terminal determines the object level of the current user based on the object information. In practical applications, a merchant may set a push level of merchant information in advance, that is, set which users corresponding to object levels have an authorization sharing authority for the merchant information. After a user terminal determines the object level of the current user, the object level is compared with the push level of the merchant information. If the object level of the current user is not lower than the push level of the object to be pushed, the current user may be authorized to share the merchant information of the merchant associated with the POI.

In some embodiments, the terminal may further transmit the merchant information of the merchant associated with the POI to a terminal corresponding to the merchant in response to a trigger operation for the confirmation function option, where the merchant information may be picture information including merchant name, location and other relevant contents, so that the terminal corresponding to the merchant may review the merchant information. When the merchant reviews that the merchant information is own merchant information, the merchant may authorize the current user to share the merchant information of the merchant associated with the POI.

In some embodiments, when an object to be pushed is a POI, after presenting merchant information of a merchant associated with the POI in a push information page, the terminal may further present a confirmation function option corresponding to the merchant information; present reward information corresponding to sharing the merchant information and an authorization function option corresponding to the reward information in response to a trigger operation for the confirmation function option; and present an authorization result indicating whether the merchant performs authorization to share the merchant information in response to a trigger operation for the authorization function option. Correspondingly, the terminal may implement the sharing of the information in response to a determination instruction for the push information, and present the information and the push portal corresponding to the push information in a corresponding sharing page by the following method: share the information in response to a determination instruction for the push information when the authorization result indicates that the merchant performs authorization to share the merchant information, and present the information and the push portal corresponding to the push information in a corresponding sharing page.

The reward information includes at least one of the following information: a unit reward and a conversion reward proportion. The unit reward refers to a reward obtained by the current user every time the merchant information shared by the current user is browsed and exposed by other users. For example, the unit reward is 0.5 yuan/person, indicating that the current user will obtain a reward of 0.5 yuan for each exposure of the merchant information. The conversion reward proportion refers to a proportion of a reward which may be obtained by the current user in a practical conversion amount after the merchant information shared by the current user is practically converted. For example, assuming that other objects consume 100 yuan according to the merchant information shared by the current user, and the conversion reward proportion is 1%, the current user may obtain a reward of 100*1%=1 yuan.

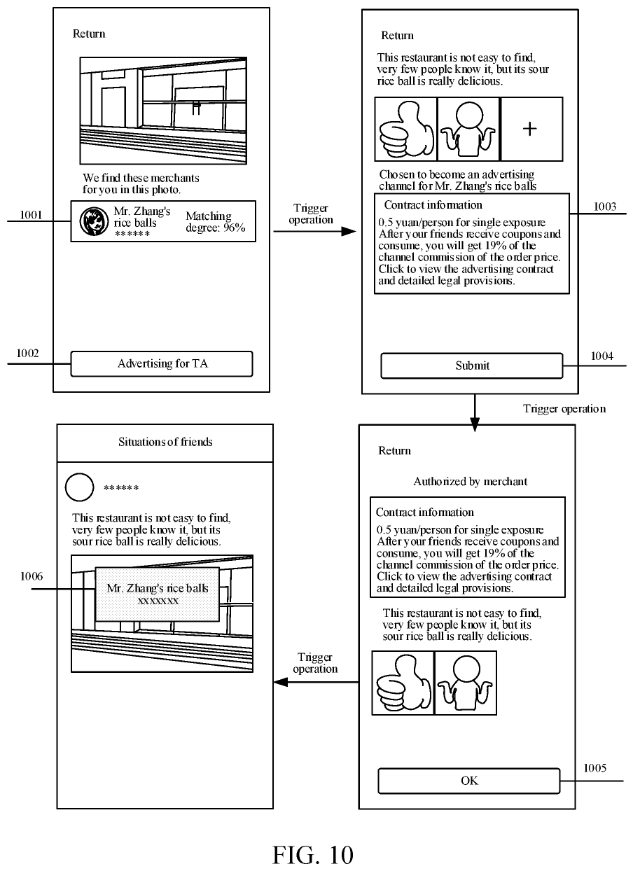

Referring to FIG. 10, FIG. 10 is a schematic diagram of an authorization interface of reward information provided by an embodiment of the present disclosure. Merchant information 1001 of a merchant associated with a POI and a confirmation function option 1002 for the merchant information are presented in a push information page. When a user triggers the confirmation function option 1002, the terminal presents reward information 1003 which may be obtained by sharing the merchant information and an authorization function option 1004 corresponding to the reward information in response to the trigger operation. When the user triggers the authorization function option 1004, the terminal presents an authorization result in response to the trigger operation. When the authorization result indicates that the merchant authorizes the current user to share the merchant information, in response to a determination instruction triggered for a confirmation function option 1005, the information is shared, and the information and the push portal 1006 corresponding to the push information are presented in a corresponding sharing page.

In some embodiments, the terminal may present reward information corresponding to sharing merchant information and an authorization function option corresponding to the reward information by the following method: present reward information of each reward level corresponding to sharing the merchant information and an authorization function option corresponding to each reward level when the reward information corresponds to at least two reward levels. Correspondingly, the terminal may present an authorization result indicating whether the merchant performs authorization to share the merchant information in response to a trigger operation for the authorization function option by the following method: presenting an authorization result indicating whether the merchant performs authorization to share the merchant information corresponding to the first reward level in response to a trigger operation for an authorization function option of a first reward level in the at least two reward levels.

The reward level corresponds to the object level one by one. The object level is related to the information of the number of fans owned by the current user or the information of the activity (such as interactive information of sharing, liking, commenting and forwarding) for the push information, where the larger the number of the push information shared by the current user, the higher the results obtained by sharing (high exposure/purchase/view), the higher the corresponding object level, and the higher the reward level.

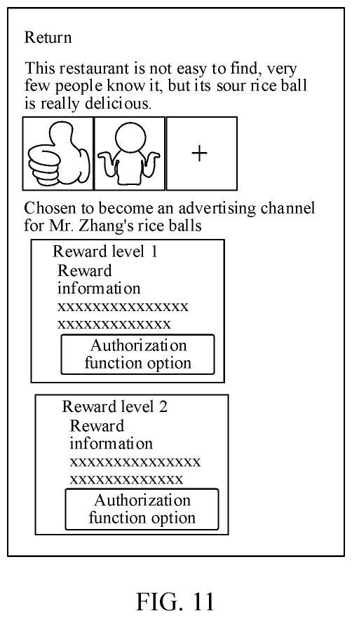

Referring to FIG. 11, FIG. 11 is a schematic diagram of an authorization interface of reward information provided by an embodiment of the present disclosure. Multiple reward levels and the reward information and authorization function option corresponding to each reward level are presented in a push information page. When a user selects an authorization function option for triggering a reward level, the terminal transmits the reward information for the selected first reward level to a terminal corresponding to a merchant in response to the trigger operation, so that the merchant terminal reviews the reward information of the first reward level selected by the current user to determine an authorization result indicating whether the current user is authorized to share the merchant information according to the first reward level.

In some embodiments, the terminal may further present a switching function option corresponding to the first reward level when the authorization result indicates that the merchant does not perform authorization to share the merchant information corresponding to the first reward level; and present an authorization result indicating whether the merchant performs authorization to share the merchant information corresponding to the second reward level in response to a selection operation for a second reward level triggered based on the switching function option.

If the first reward level is not matched with the object level of the current user, the merchant terminal returns an authorization result indicating that the current user is not authorized to share the merchant information according to the first reward level to a user terminal, and the authorization result and the switching function option for switching the first reward level are presented in a push information page of the user terminal, so as to switch the first reward level to other reward levels (such as the second reward level) through the switching function option. When other reward levels are switched, a selection operation for the second reward level may be a selection operation for an option corresponding to the second reward level, or a trigger operation for an authorization function option corresponding to the second reward level. At this time, the second reward level is a reward level which is returned by the merchant terminal and is adapted to the corresponding level of the current user.

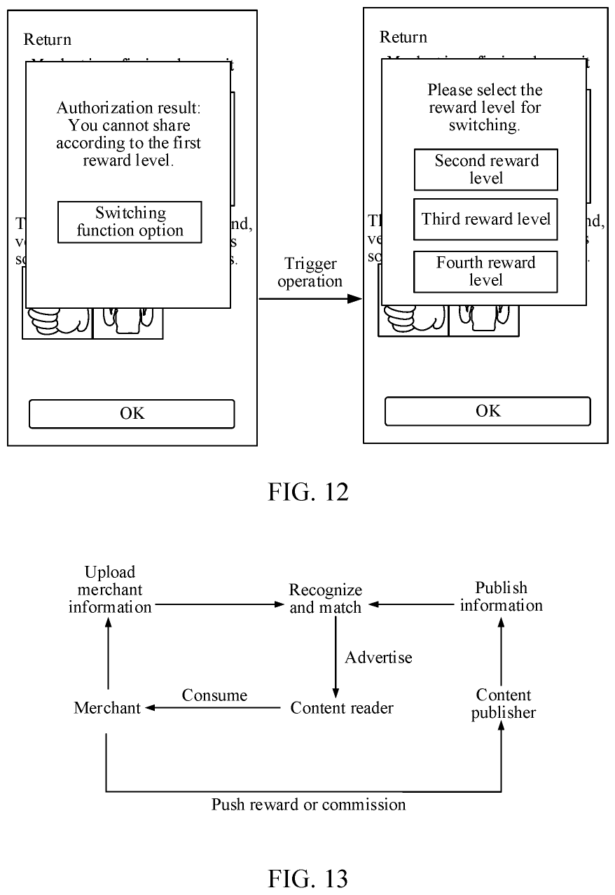

Referring to FIG. 12, FIG. 12 is a schematic diagram of an authorization interface of reward information provided by an embodiment of the present disclosure. The terminal presents a level option of at least one selectable reward level in response to a trigger operation for a switching function option, and transmits the reward information for the selected second reward level to a merchant terminal corresponding to a merchant in response to a selection operation for a second reward level in the at least one reward level based on the level option, so that the merchant terminal reviews the reward information of the second reward level selected by the current user to determine an authorization result indicating whether the current user is authorized to share the merchant information according to the second reward level.

In some embodiments, the terminal may further present a reward level adapted to the object level of the current user and the reward information corresponding to the reward level in an information page in response to a trigger operation for a confirmation function option corresponding to the merchant information, where the reward level is an appropriate level which is automatically allocated to a user terminal by a server based on the object level of the current user.

In some embodiments, the terminal may present a push portal corresponding to push information by the following method: determining a display area in the push information where the identifier of the object to be pushed is located when the push information includes an identifier of an object to be pushed; and presenting a push portal corresponding to the push information in the display area.

The identifier of the object to be pushed is a label which may represent the object to be pushed. For example, if an object to be pushed is a POI “shop”, the identifier of the object to be pushed may be a billboard, store or signboard of the shop. The push portal may be a purchase link, a promotion link, a group entry link, or an applet corresponding to the push information. For example, if the push information is an image including a shop billboard, when the image is shared, the image is presented in a sharing page, and at the same time, a push portal corresponding to the shop is displayed in a display area where the shop billboard is located in the image.

In some embodiments, when an object to be pushed is a POI and reward information includes a unit reward corresponding to single exposure of merchant information, after presenting the information and the push portal corresponding to the push information in a corresponding sharing page, the terminal may further obtain an exposure frequency of the merchant information when a reward allocation time point arrives; determine a corresponding sharing reward according to the unit reward and the exposure frequency; and allocate the sharing reward to an account associated with a current login ID.

The behavior that other users view the push portal or perform practical conversion based on the push portal may be regarded as the exposure for the merchant information. The corresponding push reward or sharing reward obtained by exposing the merchant information has a certain period of validity, and only when other users view the push portal or perform practical conversion based on the push portal within the period of validity, the current user may obtain the corresponding sharing reward. For example, the reward is computed according to the exposure frequency within seven days of information sharing, and the reward is not computed after seven days. When a reward allocation time point is determined, the exposure situations of the merchant information may be counted in real time, and the corresponding sharing reward may be determined according to the unit reward and the exposure situations. The exposure situations of the merchant information may also be counted periodically. For example, as long as the current user does not delete the shared information, the exposure frequency of the merchant information may be counted periodically, and the corresponding sharing reward may be determined according to the unit reward and the exposure frequency.

In some embodiments, when the reward information includes a unit reward corresponding to a single user viewing the merchant information based on the push portal, after presenting the information and the push portal corresponding to the push information in a corresponding sharing page, the terminal may obtain the number of users viewing the merchant information based on the push portal when a reward allocation time point arrives; determine a corresponding sharing reward according to the unit reward and the number of users; and allocate the sharing reward to an account associated with a current login ID.

In some embodiments, when the reward information includes a single purchase reward corresponding to purchasing articles associated with the merchant information based on the push portal, after presenting the information and the push portal corresponding to the push information in a corresponding sharing page, the terminal may obtain a purchase frequency of articles purchased based on the push portal when a reward allocation time point arrives; determine a corresponding sharing reward according to the single purchase reward and the purchase frequency; and allocate the sharing reward to an account associated with a current login ID.

In some embodiments, after presenting the information and the push portal corresponding to the push information in a corresponding sharing page, the terminal may further present interactive prompt information for the push information in the sharing page, where the interactive prompt information includes the information of an interactive object corresponding to the push information, and the interactive object is an object that interacts with the push information through the push portal.

After the push information is shared, the interactive prompt information of other users for the push information is presented, for example, which users read, click to view or convert the push information.

In some embodiments, after presenting the information and the push portal corresponding to the push information in a corresponding sharing page, the terminal may further present sharing reward prompt information for the push information, where the sharing reward prompt information is used for prompting that the sharing reward obtained by sharing the push information is stored in an account associated with a current user.

After the push information is shared, the reward obtained by the current user based on the interaction of other users for the push information is presented. For example, the commission obtained by the current user by pushing the push information may encourage users, which is favorable for improving the interactive enthusiasm of the users for the push information, thereby improving the conversion rate.

In some embodiments, the information processing method provided by the embodiments of the present disclosure may further be applied to an information collection scene, and may include: receive, by a terminal, a collection operation for information in an information page; present push information associated with the object to be pushed when the information includes an object to be pushed in response to the collection operation; and collect the information in response to a determination instruction for the push information, present the collected information and the push portal corresponding to the push information in a corresponding collection page for a user to save and view, subsequently, share, by the user, the collected information, and at the same time, and push the push information associated with the object to be pushed, included in the information, and the push portal of the push information to other users.

The following describes an exemplary application of this embodiment of the present disclosure in an actual application scenario. At present, the form of social advertising mainly relies on the centralized traffic allocation of a traffic platform and relies on advertising targeting conditions to select targeted groups that may achieve commercial target conditions, so as to select advertising targeting conditions consistent with the brand positioning of merchants, target groups, etc., and find groups in demand, thereby implementing targeted advertising. A lot of technologies, such as data mining, artificial intelligence, natural semantic analysis and traffic analysis, are involved. In practical applications, user demands are various, and the accuracy of a data acquisition method is affected by various uncertain factors. As a result, it is difficult to exhaust all conditions when selecting target groups, thus causing misjudgment and waste of advertising. In addition, the centralized advertising form of the traffic platform often makes users feel resistant, resulting in lower advertising conversion efficiency.

Furthermore, since star users with a large number of fans serve as merchant advertising channels on social platforms, in view of stronger communication ability, a situation that big platforms, Internet celebrity users, big advertisers and big brands gradually monopolize the advertising market is gradually formed on the social platforms. However, ordinary users with a small number of fans have no chance to contact the merchant advertising channels, which is difficult for ordinary users or merchants with a small amount of advertising funds to find more appropriate commercial advertising forms in the current situation.

In view of this, an embodiment of the present disclosure provides an information processing method which includes: present push information associated with the object to be pushed when the information includes an object to be pushed in response to a sharing operation for the information during information sharing; and share the information in response to a determination instruction for the push information, and present the information and the push portal corresponding to the push information in a corresponding sharing page. The information may be videos, pictures, texts or graphic texts edited by users. For example, when a user publishes (shares) the shot photo or video of a street scene on a social platform, if the photo or video includes a billboard, the advertising information (that is, push information) of a merchant corresponding to the billboard is provided for the publisher, an advertising link (that is, push portal) associated with the advertising information is added to the photo or video and is presented in a published media page for pushing the advertising link corresponding to the billboard to other users who see the photo or video, and a corresponding push reward is provided for the publisher according to the read rate and click rate of advertising, so as to realize a decentralized personal distribution advertising ecosystem.

Referring to FIG. 13, FIG. 13 is a schematic architectural diagram of an information processing system provided by an embodiment of the present disclosure. As shown in FIG. 13, a merchant uploads the merchant information including store scenes, signboard scenes or billboard information to a social advertising platform, and provides a push portal corresponding to the merchant information, such as a purchase link, a promotion link, a group entry link, or an applet. Furthermore, the merchant may also fill in the intended advertising magnitude and pay part of the expenses as advertising funds. When a user provides authorization, when a content publisher publishes information, such as shot real photos or videos, related to the merchant information to the circle of friends, the system recognizes the photos or videos and matches the recognition results with the merchant information uploaded by the merchant, and once the matching is successful, an option indicating whether to provide a push portal for the merchant may be selected by the user in a publishing page of a user terminal. When the user provides the push portal for the merchant, the circle of friends of the user becomes a promotion channel of the merchant. After the merchant completes the review, advertisement contents may be published, such as presenting the published photos or videos in the circle of friends of the user and the push portal corresponding to the merchant information for content readers to consume. Furthermore, the user may obtain corresponding push rewards or commissions by means of charging according to the exposure frequency or profit sharing after converting advertisements into consumptions.

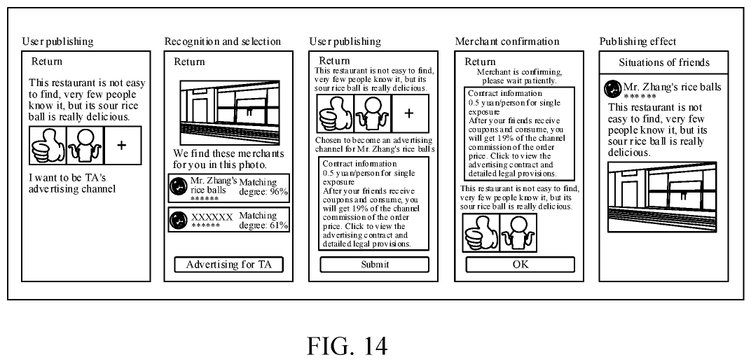

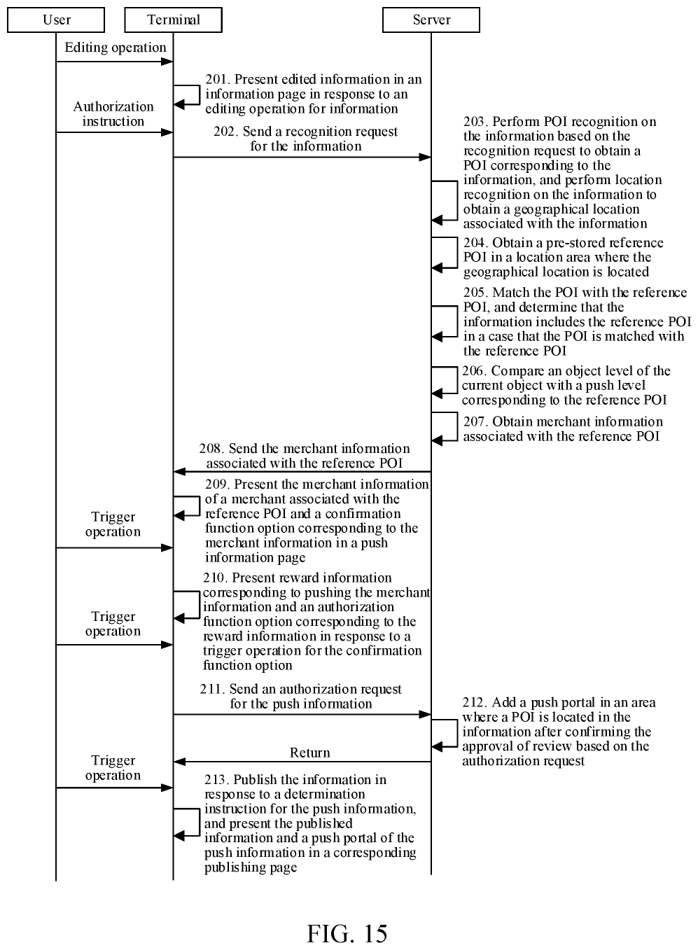

With reference to FIG. 14 and FIG. 15, an information processing method provided by an embodiment of the present disclosure is cooperatively implemented by a terminal and a server as an example for description. FIG. 14 is a schematic diagram of a product interface for information processing provided by an embodiment of the present disclosure. FIG. 15 is a schematic flowchart of an information processing method provided by an embodiment of the present disclosure.

Step 201: Present, by the terminal, edited information in an information page in response to an editing operation for information.

The information refers to edited texts and uploaded photos or videos when a user edits contents in the information page.

Step 202: Transmit, by the terminal, a recognition request for the information to the server in response to a recognition authorization instruction for the information.

After the user is authorized to recognize the information, the terminal transmits the recognition request for information recognition to the server for subsequent processing, where the recognition request carries the information and a user identifier of a current user.

Step 203: Perform POI recognition on the information by the server based on the recognition request to obtain a POI corresponding to the information, and perform location recognition on the information to obtain a geographical location associated with the information.

In practical applications, the server may input the information into a trained recognition model based on a neural network to obtain a POI corresponding to the information, that is, determine information, such as billboards, signboards or store scenes, included in the photos or videos uploaded by the user. During location recognition, the server performs location recognition on the information based on an LBS technology to obtain an associated geographical location.

Step 204: Obtain, by the server, a pre-stored reference POI in a location area where the geographical location is located.

In practical applications, a merchant uploads recognition images including merchant information, such as billboards, signboards or store scenes, to a server. In order to improve the robustness of subsequent matching, a user may upload recognition images under different lighting conditions, different weather conditions and different angles. The server performs POI recognition on the recognition image uploaded by the merchant. For example, the recognition image is inputted into the trained recognition model based on the neural network to obtain a reference POI corresponding to the merchant information, and the reference POI corresponding to each merchant is stored in the server.

Step 205: Match, by the server, the POI with the reference POI, and determine that the information includes the reference POI when the POI is matched with the reference POI.

The server matches the recognized POI with the reference POI pre-stored by the merchant. When the matching degree between the recognized POI and the reference POI exceeds a matching degree threshold, it is determined that the POI is matched with the reference POI, at this time, it is determined that the information includes the reference POI pre-stored by the merchant, and the reference POI is used as the object to be pushed. When the matching degree between the recognized POI and the reference POI is lower than a matching degree threshold, it is determined that the matching between the POI and the reference POI fails, and at this time, it is determined that the information does not include the reference POI pre-stored by the merchant.

In practical implementations, during matching, feature extraction may be performed on the recognized POI and the reference POI pre-stored by the merchant respectively, and a similarity value (such as a cosine similarity value) between the extracted features is computed. If the similarity value exceeds a similarity threshold, it is considered that the POI is matched with the reference POI. If the similarity value is lower than a similarity threshold, it is considered that the matching between the POI and the reference POI fails.

Step 206: Compare, by the server, an object level of the current user with a push level corresponding to the reference POI.

The current user is a user who publishes information. The server determines the basic information of the current user, the number of fans, and the activity for the information (such as interactions of sharing, liking, commenting and forwarding) based on the user identifier carried by the recognition request, so as to determine the current user level. When uploading the merchant information, the merchant sets the advertising magnitude (that is, push level) of the reference POI, and the object level corresponds to the push level one by one, so the server may obtain the push level corresponding to the reference POI and compare the object level of the current user with the push level corresponding to the reference POI. If the object level of the current user is not lower than the push level of the reference POI, it indicates that the current user has an advertising authority for the reference POI.

Step 207: Obtain, by the server, merchant information associated with the reference POI.

The merchant information is push information for an object to be pushed, namely the reference POI, such as the name, address, comment exposure price and other information of the merchant.

Step 208: Transmit, by the server, the merchant information associated with the reference POI to a terminal.

Step 209: Present, by the terminal, the merchant information of a merchant associated with the reference POI and a confirmation function option corresponding to the merchant information in a push information page.

When the user provides advertising for the merchant, the user may click the confirmation function option “Advertising for TA” as shown in FIG. 14.

Step 210: Present, by the terminal, reward information corresponding to pushing the merchant information and an authorization function option corresponding to the reward information in response to a trigger operation for the confirmation function option.

The reward information may also become contract information, including at least one of the following information: a unit reward and a conversion reward proportion. The unit reward refers to a reward obtained by the current user every time the merchant information shared by the current user is browsed and exposed by other users. For example, the unit reward is 0.5 yuan/person, indicating that the current user will obtain a reward of 0.5 yuan for each exposure of the merchant information. The conversion reward proportion refers to a proportion of a reward which may be obtained by the current user in a practical conversion amount after the merchant information shared by the current user is practically converted. For example, assuming that other objects consume 100 yuan according to the merchant information shared by the current user, and the conversion reward proportion is 1%, the current user may obtain a reward of 100*1%=1 yuan.

After confirming the contract information, the user may click an authorization function option “Submit” as shown in FIG. 14.

Step 211: Transmit, by the terminal, an authorization request for pushing merchant information to the server in response to a trigger operation for the authorization function option.

Step 212: Add a push portal in an area where a POI is located in the information after the server confirms the approval of review based on the authorization request.

The authorization request carries the merchant information and the corresponding reward information. The server reviews the merchant information and the reward information based on the authorization request. If the merchant is the own merchant, the current user may be authorized to advertise the merchant information. A clickable advertising label, namely a push portal corresponding to the push information, is generated in an area where a POI is located in a picture or video of the information, and is presented in the terminal.

Step 213: Publish, by the terminal, the information in response to a determination instruction for the push information, and present the published information and a push portal corresponding to the push information in a corresponding publishing page.

For example, when a user triggers a function option “OK” in FIG. 14, the terminal publishes the information based on a determination instruction triggered by the trigger operation, so the published photos or videos and the push portal corresponding to the merchant information are presented in the circle of friends of the user. Furthermore, when other users generate read exposure or conversion on the push portal, the server may further obtain read exposure or conversion data, that is, determine the corresponding benefits, so as to generate a bill according to the benefits. After the merchant confirms the bill, the advertising expense is deducted from the merchant account to the account associated with the current user to obtain the corresponding push reward or commission.

Through the above methods, a decentralized commercial advertising ecosystem may be formed, so that ordinary users with a small number of friends or fans on social platforms may also play the traffic value, so that small and medium-sized merchants may achieve more reasonable and in-depth commercial advertising effects. Moreover, the relationship chains of ordinary users are more based on the real life. When friends in the real life see the advertisements of real photos published by the ordinary users, the credibility is higher in the circle of friends, thereby being favorable for improving the conversion rate and achieving more accurate advertising effects.

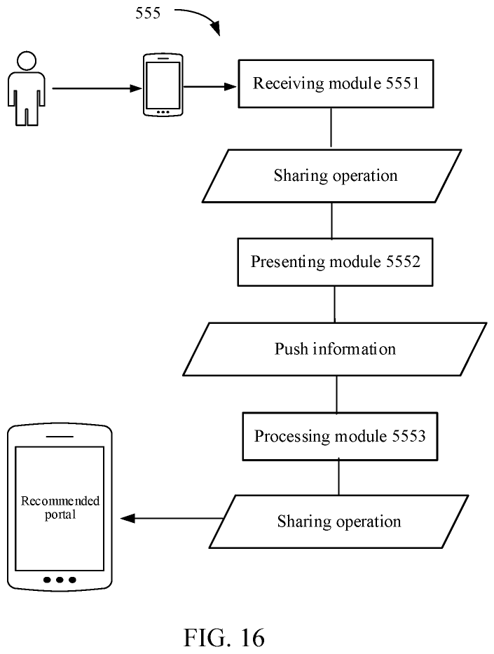

The following describes an exemplary structure of an information processing apparatus 555 provided by an embodiment of the present disclosure implemented as a software module. In some embodiments, referring to FIG. 16, FIG. 16 is a schematic structural diagram of an information processing apparatus provided by an embodiment of the present disclosure. A software module stored in the information processing apparatus 555 of the memory 550 in FIG. 2 may include:

a receiving module 5551 configured to receive a sharing operation for information in an information page;

a presenting module 5552 configured to present push information associated with the object to be pushed when the information includes an object to be pushed in response to the sharing operation; and

a processing module 5553 configured to share the information in response to a determination instruction for the push information, and present the information and the push portal corresponding to the push information in a corresponding sharing page.

In some embodiments, the receiving module is further configured to present an information option in the chat page when the information page is a chat page between a current user and a target sharing user; and

receive an information addition operation for the information based on the information option, and use the information addition operation as a sharing operation for the information.

The present the information and the push portal corresponding to the push information in a corresponding sharing page includes:

presenting the information and the push portal corresponding to the push information in the chat page.

In some embodiments, after the receive a sharing operation for information in an information page, the apparatus further includes:

an authorization module configured to present push authorization information corresponding to the information, the push authorization information being used for obtaining the push authorization for the object to be pushed in the information.

Correspondingly, the presenting module is further configured to present push information associated with the object to be pushed when the information includes an object to be pushed in response to an authorization instruction triggered for the push authorization information.

In some embodiments, before the present push information associated with the object to be pushed, the apparatus further includes:

a sharing mode setting module configured to present a sharing setting interface of information, and present a sharing push function option in the sharing setting interface; and

set a sharing mode of information to a sharing push mode in response to a trigger operation for the sharing push function option.

Correspondingly, the presenting module is further configured to present push information associated with the object to be pushed when a sharing mode of information is a sharing push mode and the information includes an object to be pushed.

In some embodiments, the presenting module is further configured to present an object selection page corresponding to the at least two objects to be pushed when there are at least two objects to be pushed; and

present push information associated with the target push object in response to a selection operation for a target push object in the object selection page.

In some embodiments, the presenting module is further configured to obtain a sharing reference feature corresponding to the information when there are at least two objects to be pushed, where the sharing reference feature includes at least one of the following: a conversion rate corresponding to each of the push objects, and an user feature of a target sharing user of the information; and

invoking a machine learning model for prediction processing based on the sharing reference feature to obtain a target push object to be pushed, and presenting push information associated with the target push object.

In some embodiments, before the present push information associated with the object to be pushed, the apparatus further includes:

a push information determining module configured to receive a selection instruction for target push information in the at least two pieces of push information when there are at least two pieces of push information; and

use the target push information as push information to be shared in response to the selection instruction.

Correspondingly, the processing module is further configured to share the information in response to a determination instruction for the target push information, and present the information and the push portal corresponding to the target push information in a corresponding sharing page.

In some embodiments, the presenting module is further configured to obtain an object level of a current user and a push level corresponding to the push object when the information includes an object to be pushed; and

present push information associated with the object to be pushed when the object level is not lower than the push level.

In some embodiments, the presenting module is further configured to turn the page to a push information page when the object to be pushed is a POI, present merchant information of a merchant associated with the POI in the push information page, and use the merchant information as the push information.

Correspondingly, the processing module is further configured to share the information in response to a determination instruction for the merchant information, and present the information and the push portal corresponding to the merchant information in a corresponding sharing page.

In some embodiments, after the present merchant information of a merchant associated with the POI in the push information page, the apparatus further includes:

a determination instruction triggering module configured to present a confirmation function option corresponding to the merchant information;

transmit object information of a current user to a terminal corresponding to the merchant in response to a trigger operation for the confirmation function option; and

trigger a determination instruction for the merchant information when an authorization sharing instruction triggered by the merchant based on the object information is received.

In some embodiments, after the present merchant information of a merchant associated with the POI in the push information page, the apparatus further includes:

a reward authorization module configured to present a confirmation function option corresponding to the merchant information;

present reward information corresponding to sharing the merchant information and an authorization function option corresponding to the reward information in response to a trigger operation for the confirmation function option; and

present an authorization result indicating whether the merchant performs authorization to share the merchant information in response to a trigger operation for the authorization function option.

Correspondingly, the processing module is further configured to share the information in response to a determination instruction for the push information when the authorization result indicates that the merchant performs authorization to share the merchant information, and present the information and the push portal corresponding to the push information in a corresponding sharing page.

In some embodiments, when the reward information includes a unit reward corresponding to single exposure of the merchant information, the apparatus further includes:

a reward allocation module configured to obtain an exposure frequency of the merchant information when a reward allocation time point arrives;

determine a corresponding sharing reward according to the unit reward and the exposure frequency; and

allocate the sharing reward to an account associated with a current login ID.

In some embodiments, when the reward information includes a unit reward corresponding to a single user viewing the merchant information based on the push portal, the reward allocation module is further configured to obtain the number of users viewing the merchant information based on the push portal when a reward allocation time point arrives;

determine a corresponding sharing reward according to the unit reward and the number of users; and

allocate the sharing reward to an account associated with a current login ID.

In some embodiments, when the reward information includes a single purchase reward corresponding to purchasing articles associated with the merchant information based on the push portal, the reward allocation module is further configured to obtain a purchase frequency of articles purchased based on the push portal when a reward allocation time point arrives;

determine a corresponding sharing reward according to the single purchase reward and the purchase frequency; and

allocate the sharing reward to an account associated with a current login ID.

In some embodiments, the reward authorization module is further configured to present reward information of each reward level corresponding to sharing the merchant information and an authorization function option corresponding to each reward level when the reward information corresponds to at least two reward levels; and

present an authorization result indicating whether the merchant performs authorization to share the merchant information corresponding to the first reward level in response to a trigger operation for an authorization function option of a first reward level in the at least two reward levels.

In some embodiments, the apparatus further includes:

a reward level switching module configured to present a switching function option corresponding to the first reward level when the authorization result indicates that the merchant does not perform authorization to share the merchant information corresponding to the first reward level; and

present an authorization result indicating whether the merchant performs authorization to share the merchant information corresponding to the second reward level in response to a selection operation for a second reward level triggered based on the switching function option.

In some embodiments, the processing module is further configured to determine a display area in the push information where the identifier is located when the push information includes an identifier of the object to be pushed; and

present a push portal corresponding to the push information in the display area.

In some embodiments, the apparatus further includes:

an interactive prompt module configured to present interactive prompt information for the push information in the sharing page, the interactive prompt information including information of an interactive object corresponding to the push information.

The interactive object is an object that interacts with the push information through the push portal.

In some embodiments, the apparatus further includes:

a reward prompt module configured to present sharing reward prompt information for the push information, the sharing reward prompt information being configured to prompt that the sharing reward obtained by sharing the push information is stored in an account associated with a current user.

In some embodiments, before the present push information associated with the object to be pushed, the apparatus further includes:

a recognition module configured to perform object recognition on the information to obtain at least one object included in the information; and

respectively match each of the objects with the pre-stored object to be pushed, and determine that the information includes the object to be pushed when there is an object matched with the object to be pushed.

In some embodiments, when the object to be pushed is a POI, before the present push information associated with the object to be pushed, the recognition module is further configured to perform POI recognition on the information to obtain a POI corresponding to the information, and perform location recognition on the information to obtain a geographical location associated with the information;

obtain a pre-stored reference POI in a location area where the geographical location is located; and

match the POI with the reference POI, and determine that the information includes the reference POI when the POI is matched with the reference POI, so as to use the reference POI as the object to be pushed.

In some embodiments, the receiving module is further configured to present an information editing function option in an information page;

present the edited information and a sharing function option corresponding to the information in the information page in response to an information editing operation triggered based on the information editing function option; and

receive a sharing operation for the information triggered based on the sharing function option.

In some embodiments, the receiving module is further configured to present a sharing function option for the information in the detail page when the information page is a detail page of information;

present an object option including at least one sharing object in response to a trigger operation for the sharing function option; and

receive a selection operation for a target object in the at least one sharing object triggered based on the object option as a sharing operation for the information.

The present the information and the push portal corresponding to the push information in a corresponding sharing page includes:

presenting a chat page between a current user and the target object, and presenting the information and the push portal corresponding to the push information in the chat page.

An embodiment of the present disclosure provides a computer program product or a computer program, the computer program product or the computer program including computer instructions, the computer instructions being stored in a computer-readable storage medium. A processor of a computer device reads the computer instructions from the computer-readable storage medium, and executes the computer instructions, to cause the computer device to perform the foregoing information processing method in this embodiment of the present disclosure.

An embodiment of the present disclosure provides a computer-readable storage medium storing an executable instruction. When the executable instruction is executed by a processor, the processor is caused to perform the information processing method in the embodiments of the present disclosure.

In some embodiments, the computer-readable storage medium may be a memory such as an FRAM, a ROM, a PROM, an EPROM, an EEPROM, a flash memory, a magnetic surface memory, an optical disk, or a CD-ROM; or may be any device including one of or any combination of the foregoing memories.

In some embodiments, the executable instructions can be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

In an example, the executable instructions may be deployed to be executed on a computing device, or deployed to be executed on a plurality of computing devices at the same location, or deployed to be executed on a plurality of computing devices that are distributed in a plurality of locations and interconnected by using a communication network.

The foregoing descriptions are merely embodiments of the present disclosure and are not intended to limit the protection scope of the present disclosure. Any modification, equivalent replacement, or improvement made without departing from the spirit and range of the present disclosure shall fall within the protection scope of the present disclosure.

What is claimed is:

1. An information processing method performed by a computer device, the method comprising:
receiving a sharing operation for information in an information page, the information comprises an object to be pushed;
in response to the sharing operation, presenting push information associated with the object; and
sharing the information in response to a determination instruction for the push information, and
presenting the information and a push portal corresponding to the push information in a corresponding sharing page.

2. The method according to claim 1, wherein the information page is a chat page between a current user and a target sharing user, and the receiving a sharing operation for information in an information page comprises:
presenting an information option in the chat page;
receiving an information addition operation for the information based on the information option, and using the information addition operation as the sharing operation for the information; and
the presenting the information and the push portal corresponding to the push information in a corresponding sharing page comprises:
presenting the information and the push portal corresponding to the push information in the chat page.

3. The method according to claim 1, wherein after the receiving a sharing operation for information in an information page, the method further comprises:
presenting push authorization information corresponding to the information, the push authorization information being used for obtaining the push authorization for the object to be pushed in the information; and
presenting push information associated with the object comprises:
presenting the push information associated with the object in response to an authorization instruction triggered for the push authorization information.

4. The method according to claim 1, wherein the method further comprises:
presenting a sharing setting interface of information, and presenting a sharing push function option in the sharing setting interface;
setting a sharing mode of information to a sharing push mode in response to a trigger operation for the sharing push function option; and
the presenting push information associated with the object comprises:
presenting push information associated with the object when a sharing mode of information is a sharing push mode.

5. The method according to claim 1, wherein the information comprises at least two objects to be pushed, and the presenting push information associated with the object comprises:
presenting an object selection page corresponding to the at least two objects to be pushed; and
presenting push information associated with the target push object in response to a selection operation for a target push object in the object selection page.

6. The method according to claim 1, wherein the information comprises at least two objects to be pushed, and the presenting push information associated with the object to be pushed comprises:
obtaining a sharing reference feature corresponding to the information, wherein the sharing reference feature comprises at least one of: a conversion rate corresponding to each of the push objects, or a user feature of a target sharing user of the information; and
invoking a machine learning model for prediction processing based on the sharing reference feature to obtain a target push object to be pushed, and presenting push information associated with the target push object.

7. The method according to claim 1, wherein the method further comprises:
receiving a selection instruction for target push information in the at least two pieces of push information when there are at least two pieces of push information;
using the target push information as push information to be shared in response to the selection instruction; and
the sharing the information in response to a determination instruction for the push information, and presenting the information and the push portal corresponding to the push information in a corresponding sharing page comprises:
sharing the information in response to a determination instruction for the target push information, and presenting the information and the push portal corresponding to the target push information in a corresponding sharing page.

8. The method according to claim 1, wherein the presenting push information associated with the object comprises:
obtaining an object level of a current user and a push level corresponding to the push object when the information comprises an object to be pushed; and
presenting push information associated with the object to be pushed when the object level is not lower than the push level.

9. The method according to claim 1, wherein presenting push information associated with the object comprises:
turning the page to a push information page when the object to be pushed is a point of interest (POI), presenting merchant information of a merchant associated with the POI in the push information page, and using the merchant information as the push information; and
the sharing the information in response to a determination instruction for the push information, and presenting the information and the push portal corresponding to the push information in a corresponding sharing page comprises:
sharing the information in response to a determination instruction for the merchant information, and presenting the information and the push portal corresponding to the merchant information in a corresponding sharing page.

10. The method according to claim 9, wherein after the presenting merchant information of a merchant associated with the POI in the push information page, the method further comprises:
presenting a confirmation function option corresponding to the merchant information;
transmitting object information of a current user to a terminal corresponding to the merchant in response to a trigger operation for the confirmation function option; and
triggering a determination instruction for the merchant information when an authorization sharing instruction triggered by the merchant based on the object information is received.

11. The method according to claim 9, wherein after the presenting merchant information of a merchant associated with the POI in the push information page, the method further comprises:
presenting a confirmation function option corresponding to the merchant information;
presenting reward information corresponding to sharing the merchant information and an authorization function option corresponding to the reward information in response to a trigger operation for the confirmation function option;
presenting an authorization result indicating whether the merchant performs authorization to share the merchant information in response to a trigger operation for the authorization function option; and
the sharing the information in response to a determination instruction for the push information, and presenting the information and the push portal corresponding to the push information in a corresponding sharing page comprises:
sharing the information in response to a determination instruction for the push information when the authorization result indicates that the merchant performs authorization to share the merchant information, and presenting the information and the push portal corresponding to the push information in a corresponding sharing page.

12. The method according to claim 11, wherein the presenting reward information corresponding to sharing the merchant information and an authorization function option corresponding to the reward information comprises:
presenting reward information of each reward level corresponding to sharing the merchant information and an authorization function option corresponding to each reward level when the reward information corresponds to at least two reward levels; and
the presenting an authorization result indicating whether the merchant performs authorization to share the merchant information in response to a trigger operation for the authorization function option comprises:
presenting an authorization result indicating whether the merchant performs authorization to share the merchant information corresponding to the first reward level in response to a trigger operation for an authorization function option of a first reward level in the at least two reward levels.

13. The method according to claim 12, wherein the method further comprises:
presenting a switching function option corresponding to the first reward level when the authorization result indicates that the merchant does not perform authorization to share the merchant information corresponding to the first reward level; and
presenting an authorization result indicating whether the merchant performs authorization to share the merchant information corresponding to the second reward level in response to a selection operation for a second reward level triggered based on the switching function option.

14. The method according to claim 11, wherein when the reward information comprises a unit reward corresponding to single exposure of the merchant information, the method further comprises:
obtaining an exposure frequency of the merchant information when a reward allocation time point arrives;
determining a corresponding sharing reward according to the unit reward and the exposure frequency; and
allocating the sharing reward to an account associated with a current login ID.

15. The method according to claim 1, wherein the presenting a push portal corresponding to the push information comprises:
determining a display area in the push information where the identifier is located when the push information comprises an identifier of the object to be pushed; and
presenting a push portal corresponding to the push information in the display area.

16. The method according to claim 1, wherein the method further comprises:
presenting interactive prompt information for the push information in the sharing page, the interactive prompt information comprising information of an interactive object corresponding to the push information, wherein
the interactive object is an object that interacts with the push information through the push portal.

17. The method according to claim 1, wherein the method further comprises:
presenting sharing reward prompt information for the push information, the sharing reward prompt information being used for prompting that the sharing reward obtained by sharing the push information is stored in an account associated with a current user.

18. The method according to claim 1, wherein the object to be pushed is a POI, and the method further comprises:
performing POI recognition on the information to obtain a POI corresponding to the information, and performing location recognition on the information to obtain a geographical location associated with the information;
obtaining a pre-stored reference POI in a location area where the geographical location is located; and
matching the POI with the reference POI, and determining that the information comprises the reference POI when the POI is matched with the reference POI, so as to use the reference POI as the object to be pushed.

19. An information processing apparatus, comprising:
a memory, configured to store executable instructions; and
a processor, configured to implement:
receiving a sharing operation for information in an information page, the information comprises an object to be pushed;
in response to the sharing operation, presenting push information associated with the object; and
sharing the information in response to a determination instruction for the push information, and
presenting the information and a push portal corresponding to the push information in a corresponding sharing page.

20. A non-transitory computer-readable storage medium, storing executable instructions, the executable instructions, when executed by a processor, causing the processor to perform:
receiving a sharing operation for information in an information page, the information comprises an object to be pushed;
in response to the sharing operation, presenting push information associated with the object; and
sharing the information in response to a determination instruction for the push information, and
presenting the information and a push portal corresponding to the push information in a corresponding sharing page.
